(19) United States
(12) Patent Application Publication
(10) Pub. No.: US 2004/0247902 A1
(43) Pub. Date: Dec. 9, 2004

(54) Method for producing a fire-resistant laminated veneer-covering product and the product produced thereby

(76) Inventor: Hai Tung Chuang, Tao-Yuan City (TW)

Correspondence Address: LADAS & PARRY, 5670 WILSHIRE BOULEVARD, SUITE 2100, LOS ANGELES, CA, 90036-5679, US

(21) Appl. No.: 10/457,508

(22) Filed: Jun. 9, 2003

(51) Int. Cl. B32B 15/04

(52) U.S. Cl. 428/457; 427/487; 428/532

(57) ABSTRACT

In a method for producing a fire-resistant laminated veneer-covering product, a veneer sheet is bonded to a backing sheet through a water-based fire-resistant thermosetting adhesive. Thereafter, a fire-resistant finishing layer, which includes a fire-resistant primer and a fire-resistant and abrasive-resistant topcoat, is applied on the veneer sheet. In one embodiment, the backing sheet is an aluminum foil sheet. In another embodiment, the backing sheet includes a paper layer, a fire-resistant coating and a water-resistant coating.

### BACKGROUND OF THE INVENTION

1. Field of the Invention

The invention relates to a method for producing a veneer-covering product and the product produced thereby, more particularly to a method for producing a fire-resistant laminated veneer-covering product and the product produced thereby.

2. Description of the Related Art

Veneer is a commonly used covering material for furnitures and walls so as to provide an aesthetic appearance therefor. However, in view of environmental concerns, the source of wood is limited. Additionally, veneer made entirely of wood is relatively expensive. Moreover, fire-resistance is one of the important considerations when choosing a material for architectural or decorative purposes. Since veneer is combustible, it is highly desirable to provide a veneer product which is fire-resistant and which reduces the amount of wood used for the product.

### SUMMARY OF THE INVENTION

Therefore, the object of the present invention is to provide a method for producing a laminated veneer-covering product and the product produced thereby, which is fire-resistant and which reduces the amount of wood used for the product.

In one aspect, a method for producing a fire-resistant laminated veneer-covering product according to this invention includes the steps of: (a) providing a backing sheet having a front surface and a rear surface; (b) applying a water-based fire-resistant thermosetting adhesive on the front surface of the backing sheet; (c) disposing a veneer sheet on the water-based fire-resistant thermosetting adhesive, the veneer sheet having a front surface and a rear surface in contact with the water-based fire-resistant thermosetting adhesive; (d) bonding the veneer sheet to the backing sheet through the water-based fire-resistant thermosetting adhesive; and (e) applying a fire-resistant finishing layer on the front surface of the veneer sheet. The fire-resistant finishing layer includes a fire-resistant primer having a hardness, and a fire-resistant and abrasive-resistant topcoat having a hardness higher than that of the fire-resistant primer. The step (e) is conducted by applying the fire-resistant primer on the front surface of the veneer sheet, polishing the fire-resistant primer, and applying the fire-resistant and abrasive-resistant topcoat on the fire-resistant primer.

In another aspect, a fire-resistant laminated veneer-covering product according to this invention includes a water-resistant and fire-resistant backing sheet, a water-based fire-resistant thermosetting adhesive, a veneer sheet, and a fire-resistant finishing layer. The water-resistant and fire-resistant backing sheet has a front surface and a rear surface. The water-based fire-resistant thermosetting adhesive is applied on the front surface of the backing sheet. The veneer sheet has a rear surface bonded to the front surface of the backing sheet through the water-based fire-resistant thermosetting adhesive, and further has a front surface. The fire-resistant finishing layer is applied on the front surface of the veneer sheet. The fire-resistant finishing layer includes a fire-resistant primer having a hardness and applied on the front surface of the veneer sheet, and a fire-resistant and abrasive-resistant topcoat applied on the fire-resistant primer. The fire-resistant and abrasive-resistant topcoat has a hardness higher than that of the fire-resistant primer.

### BRIEF DESCRIPTION OF THE DRAWINGS

Other features and advantages of the present invention will become apparent in the following detailed description of the preferred embodiments with reference to the accompanying drawings, of which:

FIG. 1 is a flow diagram of the first preferred embodiment of the method for producing a fire-resistant laminated veneer-covering product according to this invention;

FIGS. 2 to 4 illustrate consecutive steps of the method of the first preferred embodiment;

FIG. 5 is a sectional view of the first preferred embodiment of the fire-resistant laminated veneer-covering product according to this invention;

FIG. 6 is a flow diagram of the second preferred embodiment of the method for producing a fire-resistant laminated veneer-covering product according to this invention; and

FIG. 7 is a sectional view of the second preferred embodiment of the fire-resistant laminated veneer-covering product according to this invention.

### DETAILED DESCRIPTION OF THE PREFERRED EMBODIMENTS

Before the present invention is described in greater detail, it should be noted that like elements are denoted by the same reference numerals throughout the disclosure.

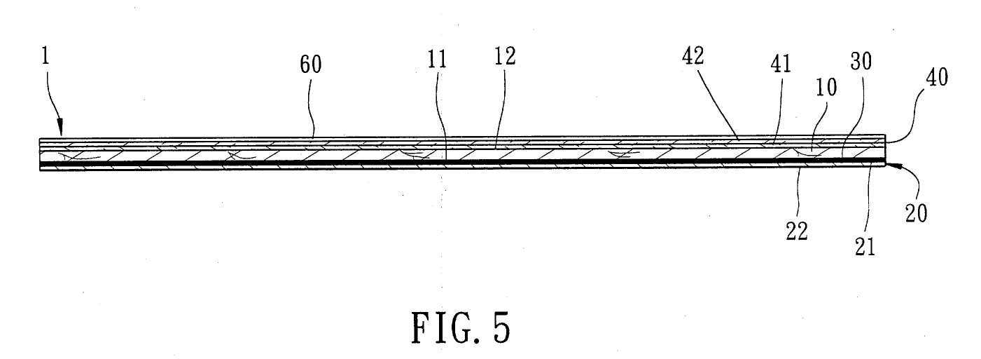

Referring to FIG. 5, the first preferred embodiment of a fire-resistant laminated veneer-covering product 1 according to this invention is shown to include a water-resistant and fire-resistant backing sheet 20, a water-based fire-resistant thermosetting adhesive 30, a veneer sheet 10, and a fire-resistant finishing layer 40.

In the first preferred embodiment, the water-resistant and fire-resistant backing sheet 20 is an aluminum foil sheet, and has a front surface 21 and a rear surface 22. The aluminum foil sheet used in this preferred embodiment is 0.3-1.5 mm in thickness.

The water-based fire-resistant thermosetting adhesive 30 is applied on the front surface 21 of the backing sheet 20. The adhesive suitable for use as the water-based fire-resistant thermosetting adhesive 30 is any suitable commercially available water-based fire-resistant thermosetting adhesive which will not produce toxic fumes in a high temperature environment. An example of the suitable water-based fire-resistant thermosetting adhesive is a commercially available water-based polystyrene emulsion.

The veneer sheet 10 has a rear surface 11 bonded to the front surface 21 of the backing sheet 20 through the water-based fire-resistant thermosetting adhesive 30, and further has a front surface 12. The size of the veneer sheet 10 varies according to the specific requirements of the customer. In the preferred embodiment, the veneer sheet 10 is 60 cm in width and 240 cm in length. Preferably, the veneer sheet 10 is pre-treated by soaking in a fire-resistant agent prior to bonding to the backing sheet 20. The fire-resistant agent can be any commercially available fire-resistant agent, an example of which is a mixture of boric acid and zinc powder.

The fire-resistant finishing layer 40 is applied on the front surface 12 of the veneer sheet 10. The fire-resistant finishing layer 40 includes a fire-resistant primer 41 applied on the front surface 12 of the veneer sheet 10, and a fire-resistant and abrasive-resistant topcoat 42 applied on the fire-resistant primer 41. The fire-resistant and abrasive-resistant topcoat 42 has a hardness higher than that of the fire-resistant primer 41. Both of the fire-resistant and abrasive-resistant topcoat 42 and the fire-resistant primer 41 are commercially available. One example of the fire-resistant primer 41 is a mixture of fire-resistant powder, ceramic powder, and transparent lacquer (such as, alkyd resin). One example of the fire-resistant and abrasive-resistant topcoat 42 is a mixture fire-resistant powder, ceramic powder, and UV-topcoat resin.

Preferably, the fire-resistant laminated veneer-covering product 1 further includes a releasable protective film 60 applied on the fire-resistant topcoat 42 of the fire-resistant finishing layer 40. The releasable protective film 60 is used for protecting the front surface of the fire-resistant laminated veneer-covering product 1 from scratch and dust, and is releasable after application on the target object. The protective film 60 can be a plastic film (such as a polyethylene film) or a paper.

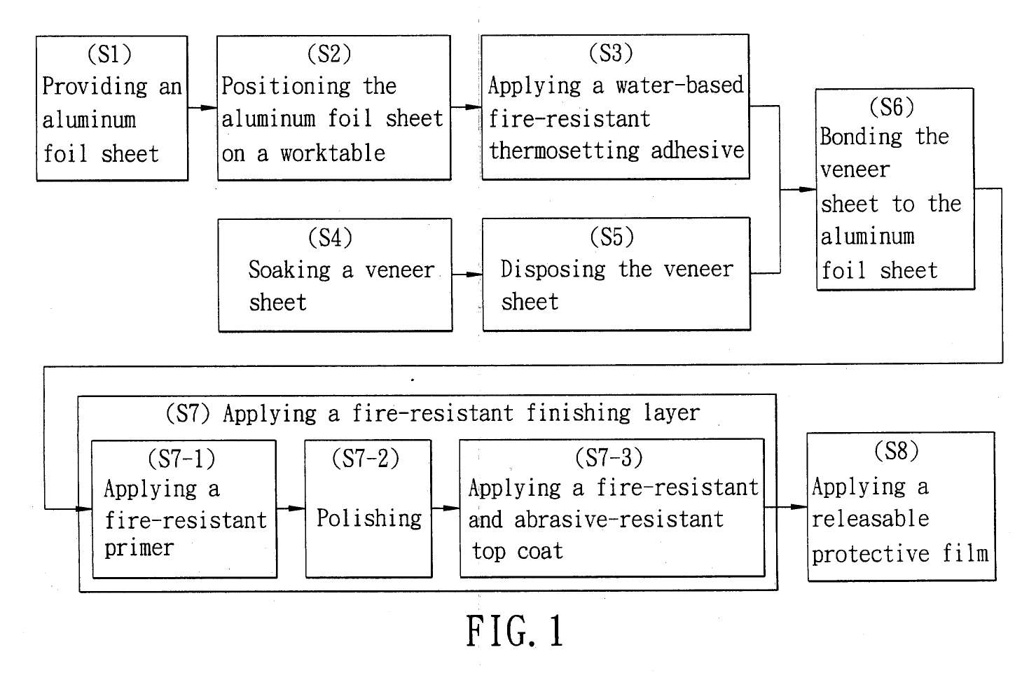

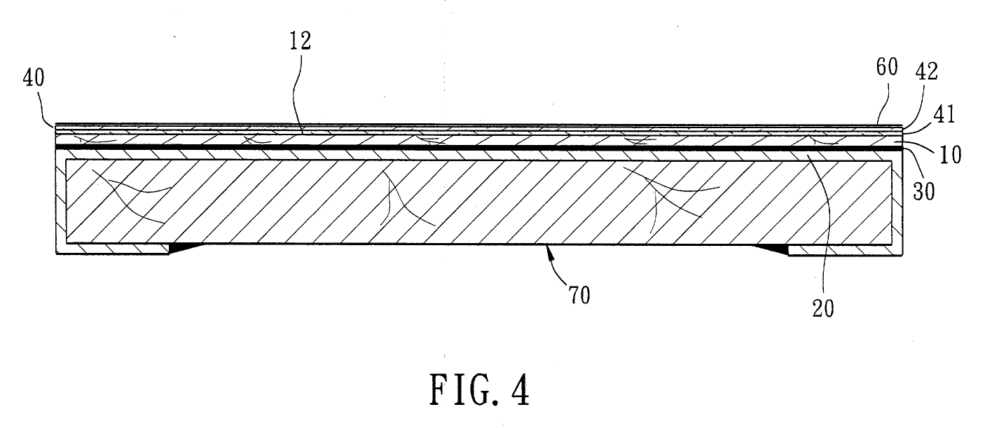

Referring to FIGS. 1 to 4, the first preferred embodiment of the method for producing the fire-resistant laminated veneer-covering product 1 according to this invention includes the steps of:

(S1) Providing an Aluminum Foil Sheet:

The aluminum foil sheet is provided for use as the backing sheet 20 of the fire-resistant laminated veneer-covering product 1. The aluminum foil sheet used in the preferred embodiment is provided by cutting from a roll of aluminum foil in an appropriate size. As described above, the aluminum foil sheet used in the preferred embodiment is 0.3-1.5 mm in thickness.

(S2) Positioning the Aluminum Foil Sheet On a Worktable 70:

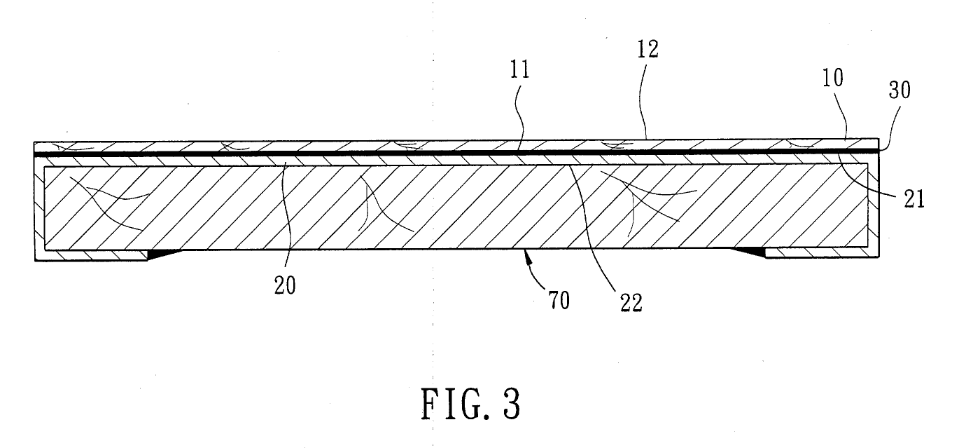

The aluminum foil sheet is positioned on the worktable 70 by folding marginal ends of the aluminum foil sheet over corresponding marginal ends of the worktable 70 so that the rear surface 22 of the aluminum foil sheet is in contact with the worktable 70, as best shown in FIG. 3.

(S3) Applying a Water-Based Fire-Resistant Thermosetting Adhesive 30:

The water-based fire-resistant thermosetting adhesive 30 is applied on the front surface 21 of the aluminum foil sheet. As described above, the water-based fire-resistant thermosetting adhesive 30 is a commercially available one which will not produce toxic fumes in a high temperature environment. The water-based fire-resistant thermosetting adhesive 30 used in the preferred embodiment is a water-based polystyrene emulsion.

(S4) Soaking a Veneer Sheet 10:

The veneer sheet 10 is soaked in a fire-resistant agent. As described above, the size of the veneer sheet 10 varies according to the specific requirements of the customer. The fire-resistant agent is a commercially available fire-resistant agent, an example of which is a mixture of boric acid and zinc powder.

(S5) Disposing the Veneer Sheet 10:

The veneer sheet 10 is disposed on the water-based fire-resistant thermosetting adhesive 30. The veneer sheet 10 has a front surface 12 and a rear surface 11 in contact with the water-based fire-resistant thermosetting adhesive 30, as best shown in FIG. 3.

(S6) Bonding the Veneer Sheet 10 to the Aluminum Foil Sheet:

The veneer sheet 10 is bonded to the aluminum foil sheet through the water-based fire-resistant thermosetting adhesive 30 by any suitable manner well known in the art, such as hot-pressing and cold-pressing. In the preferred embodiment, the bonding step is conducted by curing the water-based fire-resistant thermosetting adhesive 30 under the presence of heat and pressure.

(S7) Applying a Fire-Resistant Finishing Layer 40:

The fire-resistant finishing layer 40 includes a fire-resistant primer 41 and a fire-resistant and abrasive-resistant topcoat 42 having a hardness higher than that of the fire-resistant primer 41. The step (S7) includes the sub-steps of:

(S7-1) Applying a Fire-Resistant Primer 41:

The fire-resistant primer 41 is applied on the front surface 12 of the veneer sheet 10. As described above, a mixture of fire-resistant powder, ceramic powder, and transparent lacquer (such as, alkyd resin) can be used as the fire-resistant primer 41.

(S7-2) polishing:

The fire-resistant primer 41 is then polished after drying. The steps (S7-1) and (S7-2) can be repeated as required.

(S7-3) Applying a Fire-Resistant and Abrasive-Resistant Top Coat 42:

The fire-resistant and abrasive-resistant top coat 42 is then applied on the fire-resistant primer 41. As described above, the fire-resistant and abrasive-resistant topcoat 42 has a hardness higher than that of the fire-resistant primer 41. A mixture fire-resistant powder, ceramic powder, and UV-topcoat resin can be used as the fire-resistant and abrasive-resistant topcoat 42.

(S8) Applying a Releasable Protective Film 60:

The releasable protective film 60 is then applied on the fire-resistant finishing layer 40. As described above, the releasable protective film 60 is used for protecting the top surface of the fire-resistant laminated veneer-covering product 1 from scratch and dust, and is releasable after application on the target object.

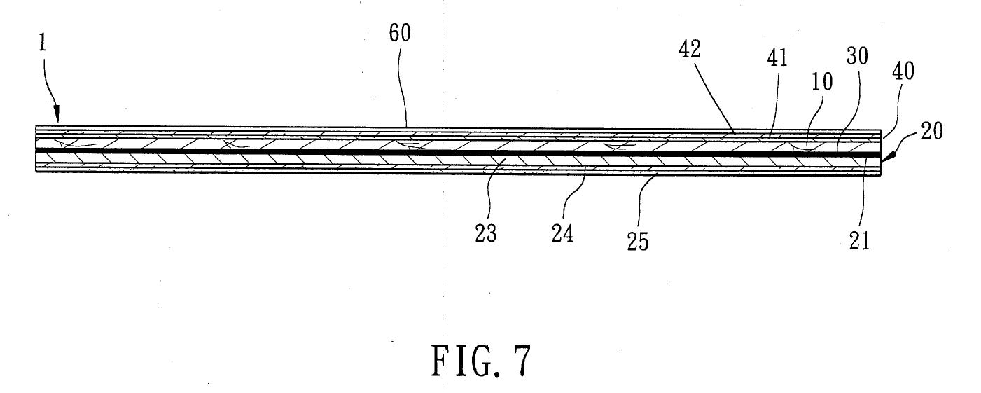

FIG. 7 illustrates the second preferred embodiment of a fire-resistant laminated veneer-covering product 1 according to this invention. The second preferred embodiment is substantially similar to the first preferred embodiment except for the construction of backing sheet 20. In the second preferred embodiment, the backing sheet 20 includes a paper layer 23 having one side that serves as the front surface 21 of the backing sheet 20. The paper layer 23 is optionally dyed to meet specific requirements. The backing sheet 20 further includes a fire-resistant coating 24 applied on another side of the paper layer 23 opposite to said one side, and a water-resistant coating 25 applied on the fire-resistant coating 24 on the paper layer 23. Both the fire-resistant coating 24 and the water-resistant coating 25 are commercially available.

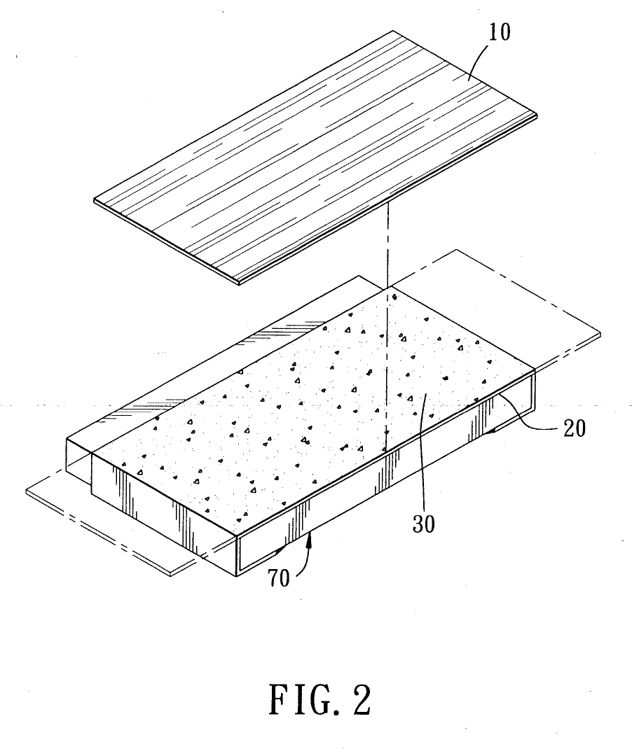

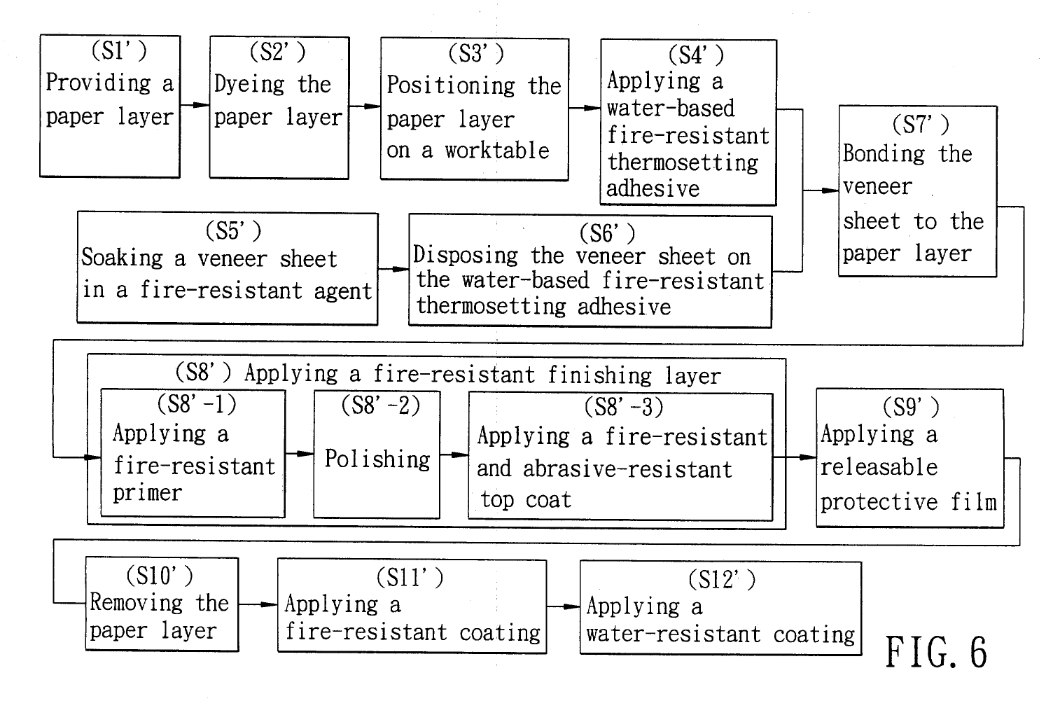

FIG. 6 illustrates a flow diagram of the second preferred embodiment of the method for producing the fire-resistant laminated veneer-covering product 1 of FIG. 7. The second preferred embodiment is substantially similar to the first preferred embodiment except for the following. A paper layer 23 is provided, which has one side that serves as the front surface 21 of the backing sheet 20. The paper layer 23 is then optionally dyed according to the specific requirement before being positioned on the worktable 70 in a manner similar to that described hereinabove (see FIG. 2). The paper layer 23 is removed from the worktable 70 after the step of applying the releasable protective film 60. The fire-resistant coating 24 is then applied on another side of the paper layer 23 opposite to said one side after removing the paper layer 23 from the worktable 70. The water-resistant coating 25 is then applied on the fire-resistant coating 24 on the paper layer 23 so that the paper layer 23 cooperates with the fire-resistant coating 24 and the water-resistant coating 25 to form the water-resistant and fire-resistant backing sheet 20.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A method for producing a fire-resistant laminated veneer-covering product, comprising the steps of:
(a) providing a backing sheet having a front surface and a rear surface;
(b) applying a water-based fire-resistant thermosetting adhesive on said front surface of said backing sheet;
(c) disposing a veneer sheet on said water-based fire-resistant thermosetting adhesive, said veneer sheet having a front surface and a rear surface in contact with said water-based fire-resistant thermosetting adhesive;
(d) bonding said veneer sheet to said backing sheet through said water-based fire-resistant thermosetting adhesive; and
(e) applying a fire-resistant finishing layer on said front surface of said veneer sheet,
wherein said fire-resistant finishing layer includes a fire-resistant primer having a hardness, and a fire-resistant and abrasive-resistant topcoat having a hardness higher than that of said fire-resistant primer, said step (e) being conducted by applying said fire-resistant primer on said front surface of said veneer sheet, polishing said fire-resistant primer, and applying said fire-resistant and abrasive-resistant topcoat on said fire-resistant primer.

2. The method as claimed in claim 1, further comprising a step of soaking said veneer sheet in a fire-resistant agent before said step (c).

3. The method as claimed in claim 1, wherein said step (d) is conducted by curing said water-based fire-resistant thermosetting adhesive under the presence of heat and pressure.

4. The method as claimed in claim 1, further comprising a step of applying a releasable protective film on said fire-resistant finishing layer after said step (e).

5. The method as claimed in claim 1, wherein said backing sheet is an aluminum foil sheet.

6. The method as claimed in claim 5, further comprising a step of positioning said backing sheet on a worktable such that said rear surface of said backing sheet is in contact with said worktable before said step (b).

7. The method as claimed in claim 6, wherein said positioning step is conducted by folding at least a marginal end of said backing sheet over a corresponding marginal end of said worktable.

8. The method as claimed in claim 1, wherein said backing sheet includes a paper layer having one side that serves as said front surface of said backing sheet.

9. The method as claimed in claim 8, further comprising a step of dyeing said paper layer before said step (b).

10. The method as claimed in claim 8, further comprising a step of positioning said paper layer of said backing sheet on a worktable such that another side of said paper layer opposite to said one side is in contact with said worktable before said step (b).

11. The method as claimed in claim 10, wherein said positioning step is conducted by folding at least a marginal end of said paper layer over a corresponding marginal end of said worktable.

12. The method as claimed in claim 10, further comprising a step of removing said paper layer of said backing sheet from said worktable after said step (e).

13. The method as claimed in claim 12, further comprising a step of applying a fire-resistant coating on said another side of said paper layer after removing said paper layer from said worktable.

14. The method as claimed in claim 13, further comprising a step of applying a water-resistant coating on said fire-resistant coating on said paper layer.

15. A fire-resistant laminated veneer-covering product, comprising:
a water-resistant and fire-resistant backing sheet having a front surface and a rear surface;
a water-based fire-resistant thermosetting adhesive applied on said front surface of said backing sheet;
a veneer sheet having a rear surface bonded to said front surface of said backing sheet through said water-based fire-resistant thermosetting adhesive, and further having a front surface; and
a fire-resistant finishing layer applied on said front surface of said veneer sheet,
wherein said fire-resistant finishing layer includes a fire-resistant primer having a hardness and applied on said front surface of said veneer sheet, and a fire-resistant and abrasive-resistant topcoat applied on said fire-resistant primer, said fire-resistant and abrasive-resistant topcoat having a hardness higher than that of said fire-resistant primer.

16. The fire-resistant laminated veneer-covering product as claimed in claim 15, wherein said veneer sheet is pre-treated by soaking in a fire-resistant agent prior to bonding to said backing sheet.

17. The fire-resistant laminated veneer-covering product as claimed in claim 15, further comprising a releasable protective film applied on said fire-resistant finishing layer.

18. The fire-resistant laminated veneer-covering product as claimed in claim 15, wherein said backing sheet is an aluminum foil sheet.

19. The fire-resistant laminated veneer-covering product as claimed in claim 15, wherein said backing sheet includes a paper layer having one side that serves as said front surface of said backing sheet.

20. The fire-resistant laminated veneer-covering product as claimed in claim 19, wherein said paper layer is a dyed paper layer.

21. The fire-resistant laminated veneer-covering product as claimed in claim 19, wherein said backing sheet further includes a fire-resistant coating applied on another side of said paper layer opposite to said one side.

22. The fire-resistant laminated veneer-covering product as claimed in claim 21, wherein said backing sheet further includes a water-resistant coating applied on said fire-resistant coating on said paper layer.
